(19) United States
(12) Patent Application Publication
(10) Pub. No.: US 2021/0259168 A1
(43) Pub. Date: Aug. 26, 2021

(54) SYSTEMS AND METHODS FOR GROWING CANNABIS PLANTS

(71) Applicant: Laust Aabye Dam, Tilbury (CA)

(72) Inventor: Laust Aabye Dam, Tilbury (CA)

(21) Appl. No.: 17/184,066

(22) Filed: Feb. 24, 2021

Related U.S. Application Data
(60) Provisional application No. 62/981,228, filed on Feb. 25, 2020.

(51) Int. Cl. A01G 22/00; A01G 7/04; A01C 21/00; A01G 9/24

(52) U.S. Cl. CPC A01G 22/00; A01G 9/246; A01C 21/00; A01G 7/045

(57) ABSTRACT

A method of growing a plurality of cannabis plants includes conveying the cannabis plants along a conveyor path in a downstream direction. The conveyor path includes a clone stage and a flower stage positioned immediately downstream of the clone stage. The method includes exposing the cannabis plants, when in the clone stage, to a light intensity of between 75-125 μmol/(s-m²) during light periods of a clone stage day-night cycle having between 18-22 hours light and 6-2 hours darkness per 24 hour period, and exposing the cannabis plants, when in the flower stage, to a light intensity of between 180-450 μmol/(s-m²) during light periods of a flower stage day-night cycle having between 10-14 hours light and 14-10 hours darkness per 24 hour period. At full maturity, the cannabis plants have an average height of 30-40 cm, an average diameter of 25-35 cm, and an average density of at least 35 plants/m².

### FIELD

The field of this application relates to systems and methods for growing cannabis plants.

### INTRODUCTION

Cannabis plants contain cannabinoids, such as tetrahydrocannabinol (THC) and cannabidiol (CBD), which can be eaten, inhaled, or otherwise absorbed into a person's body for medical, spiritual, or recreational purposes. At maturity, a female cannabis plant will include infructescences (also referred to as buds) that can have up to ten times higher levels of cannabinoids than its leaves and up to one hundred times higher levels of cannabinoids than its stalks.

### DRAWINGS

FIG. 1 is a perspective view of a system for growing cannabis plants, in accordance with an embodiment;

FIG. 2 is a top plan view of the system of FIG. 1 with lighting and humidity subsystems omitted;

FIG. 3 is an enlarge view of region A in FIG. 1;

FIG. 4 is a cross-sectional view of a plant trough containing growing medium and a cannabis plant, in accordance with an embodiment;

FIG. 5 is an illustration of a cannabis plant across progressive stages of growth;

FIG. 6 is a schematic illustration of a system control network of the apparatus of FIG. 1, in accordance with an embodiment; and

FIG. 7 is a schematic illustration of a controller of the system control network of FIG. 6, in accordance with an embodiment.

### SUMMARY

In one aspect, a method of growing a plurality of cannabis plants is provided. The method may include:
conveying the cannabis plants along a conveyor path in a downstream direction from a conveyor upstream end to a conveyor downstream end over the course of at least 50 days,
   the conveyor path including, between the conveyor upstream end and the conveyor downstream end, a clone stage having one or more sequentially arranged clone stage zones, and a flower stage having one or more sequentially arranged flower stage zones, the flower stage positioned immediately downstream of the clone stage,
exposing the cannabis plants, when in the clone stage, to a light intensity of between 75-125 μmol/(s-m²) during light periods of a clone stage day-night cycle having between 18-22 hours light and 6-2 hours darkness per 24 hour period; and
exposing the cannabis plants, when in the flower stage, to a light intensity of between 180-450 μmol/(s-m²) during light periods of a flower stage day-night cycle having between 10-14 hours light and 14-10 hours darkness per 24 hour period; and
removing the cannabis plants from the conveyor for harvesting after the cannabis plants reach the conveyor downstream end, wherein at the conveyor downstream end the cannabis plants have an average height of 30-40 cm, an average diameter of 25-35 cm, and an average density of at least 35 plants/m2.

In another aspect, a method of growing a plurality of cannabis plants is provided. The method may include:
conveying the cannabis plants along a conveyor path in a downstream direction from a conveyor upstream end to a conveyor downstream end over the course of at least 50 days,
   the conveyor path including, between the conveyor upstream end and the conveyor downstream end, a clone stage having one or more sequentially arranged clone stage zones, and a flower stage having one or more sequentially arranged flower stage zones, the flower stage positioned immediately downstream of the clone stage,
providing clone stage nutrition to the cannabis plants when in the clone stage, the clone stage nutrition having a ratio of (calcium and nitrate) to (phosphorous and potassium) of at least 3.3:1,
providing flower stage nutrition to the cannabis plants when in the flower stage, the flower stage nutrition having a ratio of (calcium and nitrate) to (phosphorous and potassium) of at least 1:1, and
removing the cannabis plants from the conveyor for harvesting after the cannabis plants reach the conveyor downstream end, wherein at the conveyor downstream end the cannabis plants have an average height of 30-40 cm, and an average density of at least 35 plants/m2.

In another aspect, a system for growing cannabis plants is provided. The system may include a conveyor and a lighting subsystem. The conveyor may have a conveyor upstream end, a conveyor downstream end, and a downstream direction. The conveyor may define a conveyor path. The conveyor path may include, between the conveyor upstream end and the conveyor downstream end, a clone stage and a flower stage. The flower stage may be positioned immediately downstream of the clone stage. The lighting subsystem may having one or more lighting modules that expose the clone stage of the conveyor path to a light intensity of between 75-125 μmol/(s-m²) during light periods of a clone stage day-night cycle having between 18-22 hours light and 6-2 hours darkness per 24 hour period. The lighting subsystem may further expose the flower stage of the conveyor path to a light intensity of between 180-450 μmol/(s-m²) during light periods of a flower stage day-night cycle having between 10-14 hours light and 14-10 hours darkness per 24 hour period.

In another aspect, a system for growing cannabis plants is provided. The system may include a conveyor and a plant nutrition subsystem. The conveyor may have a conveyor upstream end, a conveyor downstream end, and a downstream direction. The conveyor may define a conveyor path. The conveyor path may include, between the conveyor upstream end and the conveyor downstream end, a clone stage having one or more sequentially arranged clone stage zones, and a flower stage having one or more sequentially arranged flower stage zones. The flower stage may be positioned immediately downstream of the clone stage. The plant nutrition subsystem may have one or more nutrition modules that supply nutrition in the clone stage of the conveyor path with a ratio of (calcium and nitrate) to (phosphorous and potassium) of at least 3.3:1, and that supply nutrition in the flower stage of the conveyor path with a ratio of (calcium and nitrate) to (phosphorous and potassium) of at least 1:1.

### DESCRIPTION OF VARIOUS EMBODIMENTS

Numerous embodiments are described in this application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, “joined”, “affixed”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, “directly affixed”, or “directly fastened” where the parts are connected in physical contact with each other. As used herein, two or more parts are said to be “rigidly coupled”, “rigidly connected”, “rigidly attached”, “rigidly joined”, “rigidly affixed”, or “rigidly fastened” where the parts are coupled so as to move as one while maintaining a constant orientation relative to each other. None of the terms “coupled”, “connected”, “attached”, “joined”, “affixed”, and “fastened” distinguish the manner in which two or more parts are joined together.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

As used herein and in the claims, a first element is said to be ‘communicatively coupled to’ or ‘communicatively connected to’ or ‘connected in communication with’ a second element where the first element is configured to send or receive electronic signals (e.g. data) to or from the second element, and the second element is configured to receive or send the electronic signals from or to the first element. The communication may be wired (e.g. the first and second elements are connected by one or more data cables), or wireless (e.g. at least one of the first and second elements has a wireless transmitter, and at least the other of the first and second elements has a wireless receiver). The electronic signals may be analog or digital. The communication may be one-way or two-way. In some cases, the communication may conform to one or more standard protocols (e.g. SPI, I²C, Bluetooth™, or IEEE™ 802.11).

As used herein and in the claims, a group of elements are said to ‘collectively’ perform an act where that act is performed by any one of the elements in the group, or performed cooperatively by two or more (or all) elements in the group.

Some elements herein may be identified by a part number, which is composed of a base number followed by an alphabetical or subscript-numerical suffix (e.g. 112a, or 112₁). Multiple elements herein may be identified by part numbers that share a base number in common and that differ by their suffixes (e.g. 112₁, 112₂, and 112₃). All elements with a common base number may be referred to collectively or generically using the base number without a suffix (e.g. 112).

Embodiments described herein relate to systems and methods for growing cannabis plants to maturity with greater throughput density of mature plants (i.e. number of cannabis plants grown to maturity per unit time, per unit facility area) than conventional methods. A number of immature cannabis plants (i.e. a cannabis clone or seedling) may be separately deposited into spaced apart plant depositories of a plant trough. Many such plant troughs may be filled with immature cannabis plants, and then sequentially loaded onto a conveyor. The conveyor moves the plant troughs through a clone zone and then a flowering zone to a downstream conveyor end at which time the contained cannabis plants have matured and are ready to harvest. The inter-trough spacing between adjacent plant troughs increases as the plant troughs move downstream to accommodate the growing size of the contained cannabis plants.

Traditionally, cannabis plants have three stages of growth: a clone stage, a vegetative stage, and a flower stage. In embodiments disclosed herein, the vegetative stage is omitted by providing special parameters for the lighting, nutrition, and duration of the clone and flower stages. In the result, the cannabis plants may grow to maturity in less time, and may be shorter and narrower than plants grown according to traditional methods. The smaller width allows the plants to remain closer together, which increases the density of the plants at the end of the flowering stage. The smaller width and shorter growing period combine to provide greater throughput density of mature plants. In addition, the shorter plant height may allow the cannabis plants to grow without trellises, simplifying the plant trough design and conveyor system.

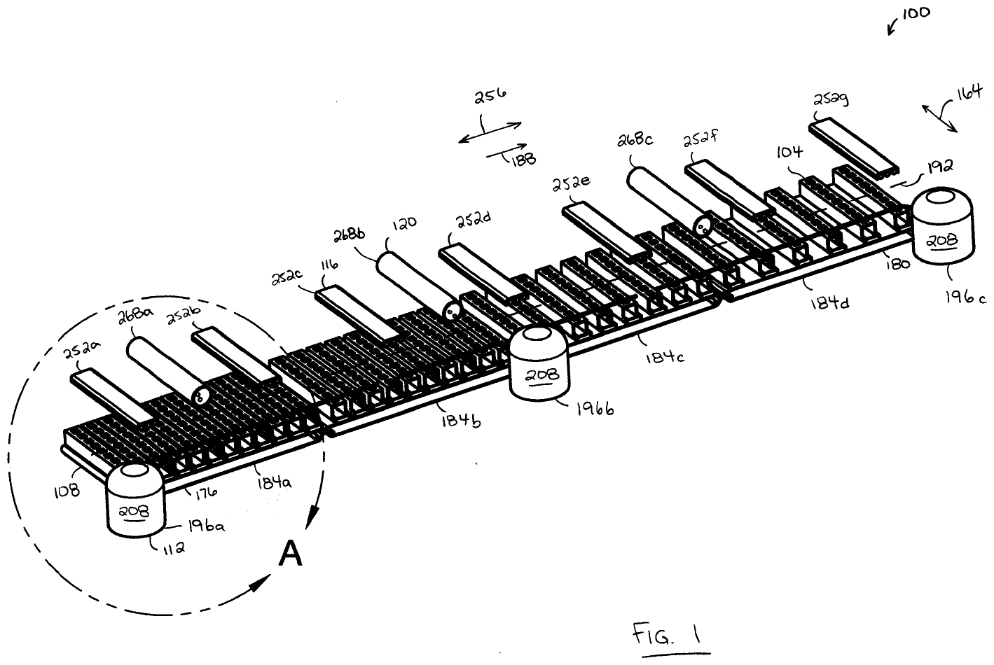

Referring to FIG. 1-3, a system 100 for growing cannabis plants is shown in accordance with an embodiment. As shown, system 100 may include a plurality of plant troughs 104, a conveyor 108, a plant nutrition subsystem 112, a lighting subsystem 116, and a humidity subsystem 120.

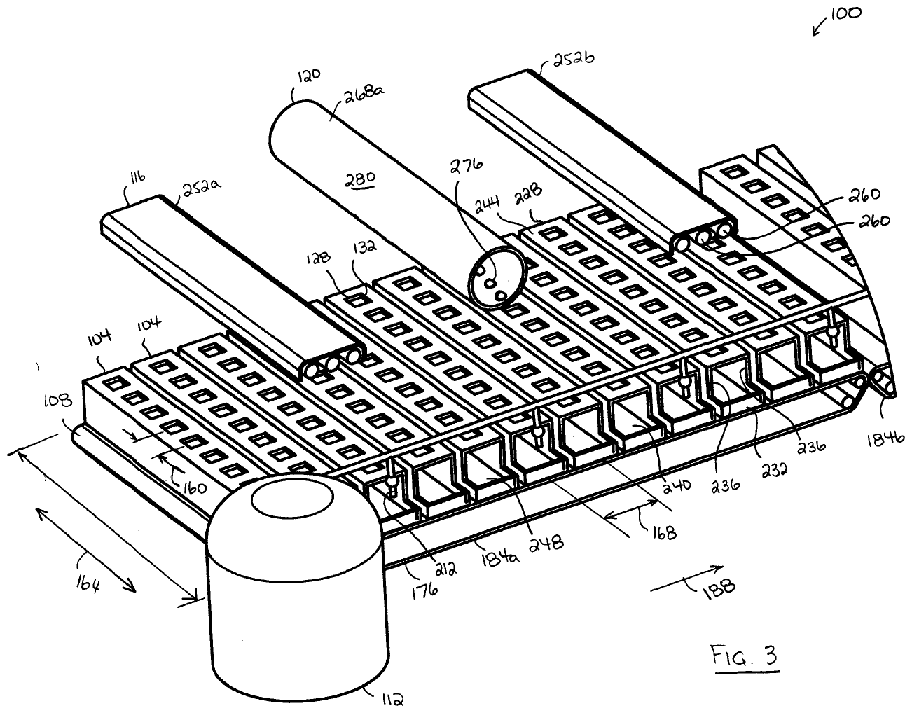

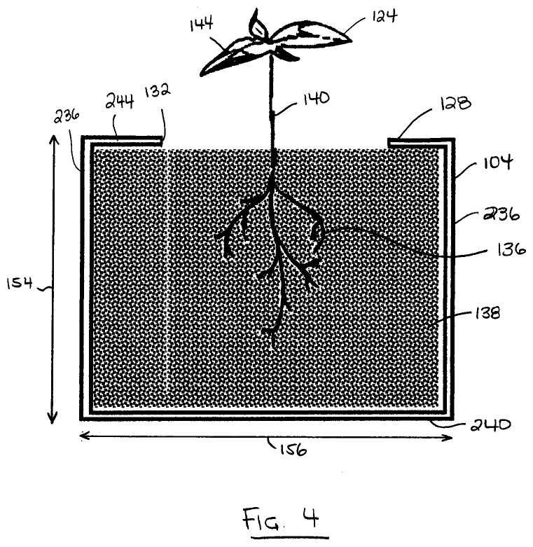

Plant troughs 104 may be any device suitable for holding a plurality of cannabis plants as they grow from immature cannabis plants (i.e. clones or seedlings) to mature cannabis plants (i.e. with buds ripe for harvest). Cannabis plants are omitted from FIGS. 1-3 so as not to obscure the drawings. Referring to FIG. 3, each plant trough 104 may include a plurality of spaced apart plant depositories 128 sized to hold a cannabis plant. Each plant depository 128 may have an upper opening 132. FIG. 4 shows a cross-section of a plant trough 104 at a plant depository 128. As shown, plant depository 128 may contain the roots 136 of cannabis plant 124 within a growing medium 138 (e.g. rockwool), and the stalk 140 of cannabis plant 124 may extend through depository opening 132 to hold leaves 144 (and eventually buds) above plant depository 128.

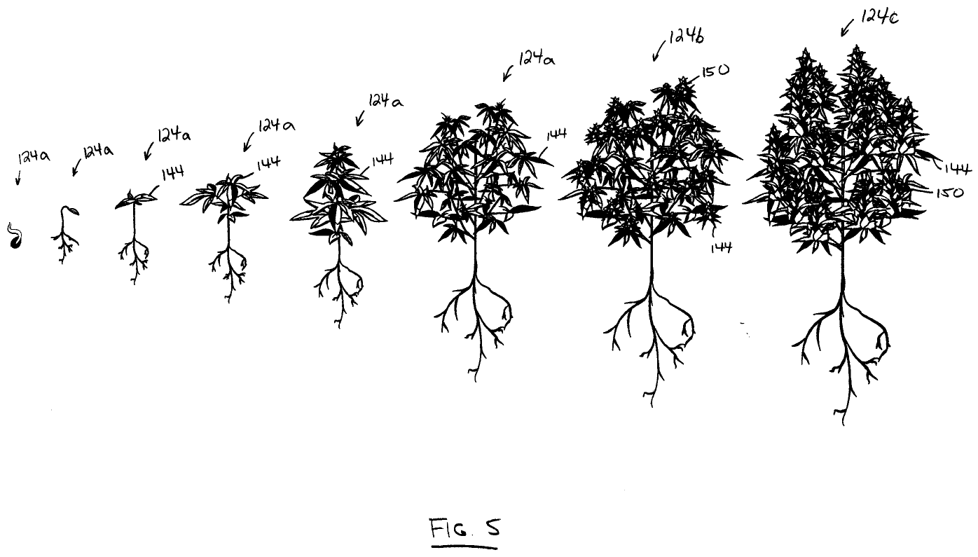

Referring to FIGS. 3-5, it is important that the cannabis plants grow their buds before harvesting, because most of the valuable cannabinoids is contained in the buds and not the leaves or the stalk. FIG. 5 shows an exemplary progression of a cannabis plant 124 from an immature plant 124a with only a few leaves 144 and no buds, to a mature plant 124c with many leaves 144 and a full complement of buds 150. Plant depositories 128 are sized to support mature cannabis plants 124c. This avoids the labor of transplanting cannabis plants to increasingly larger receptacles as they grow from immature plant to mature plant over the course of a growing duration. That is, cannabis plants 124 may remain in the same depository 128 until they have grown to full maturity and ready for harvest.

In some embodiments, plant depositories 128 may have a height 154 (e.g. depth) of 3 to 4 inches, and a machine-direction width 156 of 4 to 6 inches to provide adequate size and support for a mature plant stock and roots. Further, plant trough 104 may provide inter-depository spacing 160 of at least 6 to 10 inches (measured center to center), which may mitigate adjacent cannabis plants 124 becoming overcrowded and their leaves 144 competing for exposure to light as they approach full maturity.

Plant trough 104 may have any suitable arrangement of plant depositories 128. In some embodiments, plant depositories 128 may be distributed single-file in a cross-machine direction 164. This may permit the inter-trough spacing 168 (measured center to center), which is governed by conveyor 108, to determine the machine-direction plant spacing. Accordingly, while inter-depository spacing 160 may be sized to accommodate mature cannabis plants 124, conveyor 108 may vary the inter-trough spacing 168 for a plant trough 104 to provide only the machine-direction plant spacing required to prevent overcrowding for the expected size of cannabis plants 124 in the plant trough 104 based on the location of the plant trough 104 along conveyor 108. This may help increase the overall plant density on conveyor 108 as compared with maintaining sufficient machine-direction plant spacing 168 to accommodate mature cannabis plants over the full length of conveyor 108.

Plant trough 104 may have any number of plant depositories 128. For example, plant trough 104 may have 8 to 240 plant depositories.

Referring to FIGS. 1-3, conveyor 108 may be any device suitable for carrying plant troughs 104 along a conveyor path 192 through a plurality of environmental zones that promote the cannabis plants in plant troughs 104 to grow from immature cannabis plants (i.e. clones or seedlings) to mature cannabis plants (i.e. with buds ripe for harvest). The environmental zones may include different conditions, such as lighting, humidity, and nutrition, as provided by the plant nutrition, lighting, and humidity subsystems 112, 116, 120. In addition, conveyor 108 may provide variable inter-trough spacing 168. For example, conveyor 108 may provide an inter-trough spacing 168 that increases in downstream direction 188 between conveyor upstream end 176 and conveyor downstream end 180.

In the illustrated example, conveyor 108 may include a plurality of driven conveyor belts 184. As shown, driven conveyor belts 184 may be arranged sequentially in downstream direction 188. Each driven conveyor belt 184 may be driven at any speed. For example, as between two adjacent driven conveyor belts 184, the downstream one may be driven at a greater speed than the upstream one. This may result in the inter-trough spacing 168 of plant troughs 104 on the downstream conveyor belt 184 being greater than the inter-trough spacing 168 of plant troughs 104 on the upstream conveyor belt 184. In the example shown, conveyor 108 includes four driven conveyor belts 184a-d with respective inter-trough spacings 168a-d. Each driven conveyor belt 184b-d moves at a greater speed than the adjacent driven conveyor belt 184a-c upstream of it. Consequently, each driven conveyor belt 184b-d is shown having an inter-trough spacing 168b-d greater than the inter-trough spacing 168a-c of the adjacent driven conveyor belt 184a-c upstream of it.

It will be appreciated that conveyor 108 may have a different structure than the example shown, which still allows inter-trough spacing 168 to be varied intermittently or continuously in downstream direction 188 between conveyor upstream end 176 and conveyor downstream end 180. For example, conveyor 108 may incorporate a drive screw with a variable pitch along its length as a mechanism for providing a continuously variable inter-trough spacing.

Still referring to FIGS. 1-3, plant nutrition subsystem 112 may have any design that allows for the delivery of different nutrients to cannabis plants in different plant troughs 104 according to the position of each plant trough 104 along conveyor 108. For example, plant nutrition subsystem 112 may deliver plant nutrition that varies continuously according to position along conveyor 108, or that changes intermittently according to position along conveyor 108. In some embodiments, plant nutrition subsystem 112 may include a plurality nutrition supply modules 196. Each nutrition supply module 196 may supply nutrition to cannabis plants in plant troughs 104 located within a different region of conveyor path 192. This allows nutrition supply module 196 to provide cannabis plants with nutrition tailored for their stage of growth, as reflected by their position along conveyor path 192. As will be discussed in below, plant nutrition subsystem 112 may be configured to provide cannabis plants with nutrition formulated to promote greater throughput density of cannabis plants, in part by contributing to the cannabis plants skipping the vegetative stage of growth.

In the illustrated example, plant nutrition subsystem 112 includes three nutrition supply modules 196a-c, which supply nutrition to cannabis plants in plant troughs 104 located in sequentially arranged nutrition regions 204a-c of conveyor path 192. Accordingly, as a plant trough 104 progresses along conveyor path 192, the plant trough 104 will move from one region 204a, where it had been receiving nutrition of a first formulation from one nutrition supply module 196a, to another region 204b where it receives nutrition of a second formulation from another nutrition supply module 196b, and so forth.

Each nutrition supply module 196 may have any configuration suitable for sourcing and supplying plant nutrition to plant troughs 104 on conveyor 108. For example, nutrition supply modules 196 may include individualized or shared plant nutrition sources 208 connected to plant nutrition nozzles 212 by nutrition delivery conduits 216. In the illustrated example, each nutrition supply module 196 has a separate plant nutrition source 208, which includes a nutrition tank 220. Each nutrition tank 220 may have a different formulation of plant nutrition than the nutrition tank 220 of other nutrition supply modules 196.

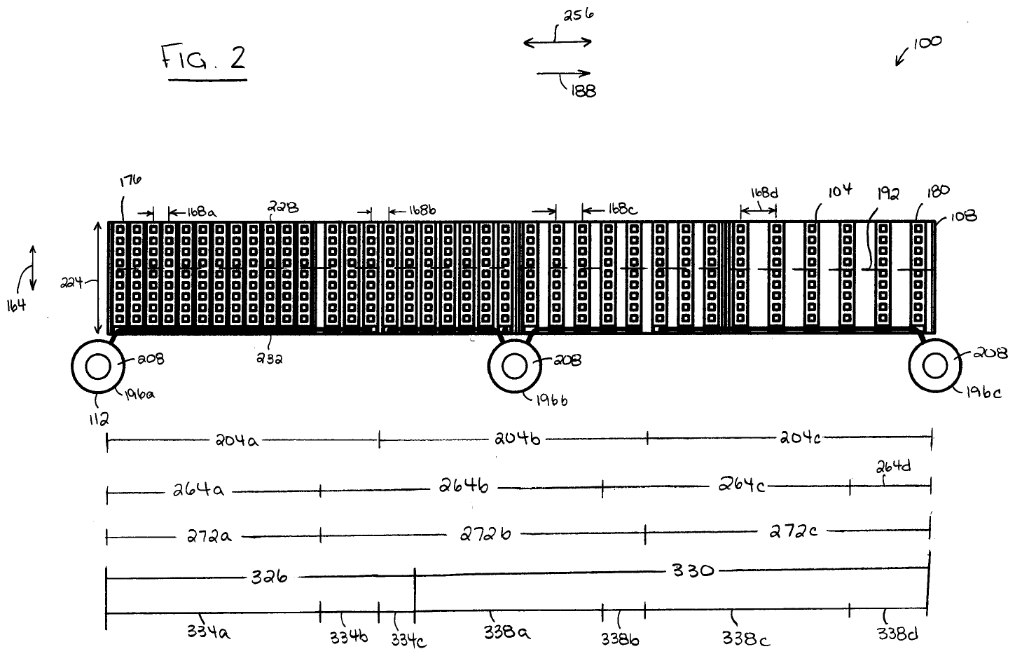

Referring to FIGS. 3-4, each plant trough 104 may have a longitudinal length 224 (FIG. 2) between plant trough ends 228, 232, oriented in the cross-machine direction 164 when carried on conveyor 108. In some embodiments, each plant trough 104 may have sidewalls 236 connected by a bottom wall 240 and an upper wall 244. Walls 236, 240, 244 may extend along longitudinal length 224. For example, each plant trough 104 may be shaped as a substantially rectangular extrusion. Additional openings may be formed in plant trough 104. For example, plant trough upper wall 244 may include plant depository openings 132 as shown. In some embodiments, length 224 may be 150 to 250 feet.

In some embodiments, plant trough 104 may further include one or more nutrition inlets 248. Nutrition inlet(s) 248 may be located anywhere on plant trough 104 suitable to provide liquid plant nutrition evenly to the cannabis plants in plant trough 104. In the illustrated example, plant trough 104 includes one nutrition inlet 248 located at plant trough end 228.

Plant nutrition nozzles 212 may be positioned to deliver liquid plant nutrition into nutrition inlets 248 of plant troughs 104. For example, plant nutrition nozzles 212 may be aligned above nutrition inlets 248 as shown. As a plant trough 104 moves along conveyor 108, its nutrition inlet 248 may periodically (or in alternative embodiments, continuously) align with a plant nutrition nozzle 212 for receiving liquid plant nutrition.

In operation, liquid plant nutrition received at nutrition inlet 248 may spread (e.g. under the influence of gravity) along the length 224 of the plant trough 104 to evenly supply nutrition to the cannabis plants 124 located in each plant depository 128 of the plant trough 104. Plant nutrition nozzles 212 may be manually operated, or may be automatically operated by a controller in accordance with a nutritional program, as described in more detail below.

In alternative embodiment, conveyor path 192 may include as many nutrition regions 204 as there are plant troughs 104 on conveyor 108. In other words, plant nutrition delivered to cannabis plants may be varied for every position along conveyor path 192. This may be achieved in any number of ways, including by having an array of separate supply lines and nozzles for every position along conveyor path 192, whereby the nutrition formulation can be varied for every position along conveyor path 192. Alternatively or in addition, there may be separate supply lines for each component of plant nutrition (e.g. calcium, nitrate, phosphorous, and potassium) and individually controllable nozzles for each nutrition component at every position along conveyor path 192, which allows different ratios of the nutrition components to be delivered to cannabis plants in plant troughs 104 at each position along conveyor path 192.

In alternative embodiments, conveyor path 192 has a single nutrition region 204, and plant nutrition subsystem 112 delivers the same nutrition formulation to cannabis plants in troughs 104 irrespective of the position of the troughs 104 along conveyor path 192.

Referring to FIGS. 1-3, lighting subsystem 116 may have any design that allows for the delivery of different lighting conditions to cannabis plants in different plant troughs 104 according to the position of each plant trough 104 along conveyor 108. For example, lighting subsystem 116 may provide lighting conditions (e.g. light-dark cycles and light intensity) that varies continuously according to position along conveyor 108, or that changes intermittently according to position along conveyor 108. In some embodiments, lighting subsystem 116 may include a plurality light supply modules 252. Each light supply module 252 may provide lighting to cannabis plants in plant troughs 104 located within a different region of conveyor path 192. This allows light supply modules 252 to provide cannabis plants with lighting conditions tailored for their stage of growth, as reflected by their position along conveyor path 192. As will be discussed below, lighting subsystem 116 may be configured to provide cannabis plants with lighting conditions that promote greater throughput density of cannabis plants, in part by contributing to the cannabis plants skipping the vegetative stage of growth.

Lighting subsystem 116 may include any number of light supply modules 252 (e.g. 3 to 300 light supply modules) distributed in the machine direction 256 over conveyor path 192 in any number of lighting regions 264. In the illustrated example, lighting subsystem 116 includes seven light supply modules 252a-g arranged into four sequentially arranged lighting regions 264a-d of conveyor path 192. Accordingly, as a plant trough 104 progresses along conveyor path 192, the plant trough 104 will move from one lighting region 264a, where it had been exposed to first lighting conditions from light supply modules 252a-b, to another lighting region 264b where it will be exposed to lighting conditions from subsequent light supply modules 252c-d, and so forth.

As shown, each light supply module 252 may include one or many light sources 260, such as for example light tubes as shown or bulbs. Each light source 260 may have any configuration suitable for providing light wavelengths necessary for plant growth. For example light sources 260 may include fluorescent grow lights, high intensity discharge grow lights, or LED grow lights. Light supply modules 252 may be situated to shine light radiation onto cannabis plants in plant troughs 104 from above, as shown. In some embodiment, every light supply module 252 is configured to provide different lighting conditions so that cannabis plants in a plant trough 104 may be exposed to continuously changing lighting conditions as the plant trough 104 travels along conveyor path 192.

In alternative embodiments, conveyor path 192 has a single lighting region 264, and lighting subsystem 116 exposes cannabis plants in troughs 104 to the same lighting conditions irrespective of the position of the troughs 104 along conveyor path 192.

Irrespective of the number of lighting regions 264, each light supply module 252 may have an intensity that is set manually (i.e. by a user) or automatically by a controller based on a lighting program. Further, each light supply module 252 may have a day-night cycle (e.g. hours of light and darkness within a 24 hour period) set manually (i.e. by a user) or automatically by a controller based on lighting program.

Still referring to FIG. 1-3, humidity subsystem 120 may have any design that allows for the delivery of different relative humidity to cannabis plants in different plant troughs 104 according to the position of each plant trough 104 along conveyor 108. For example, humidity subsystem 120 may provide a relative humidity that varies continuously according to position along conveyor 108, or that changes intermittently according to position along conveyor 108. In some embodiments, humidity subsystem 120 may include a plurality humidity supply modules 268. Each humidity supply modules 268 may expose cannabis plants in plant troughs 104 located within different regions of conveyor path 192 to different relative humidities. This allows humidity supply modules 268 to provide cannabis plants with relative humidities tailored for their stage of growth, as reflected by their position along conveyor path 192. Humidity subsystem 120 may be configured to provide cannabis plants with relative humidities that promote greater throughput density of cannabis plants, in part by contributing to the cannabis plants skipping the vegetative stage of growth.

Humidity subsystem 120 may include any number of humidity supply modules 268 (e.g. 1 to 20 humidity supply modules) distributed in the machine direction 256 over conveyor path 192 in any number of humidity regions 272. In the illustrated example, humidity subsystem 120 includes three humidity supply modules 268a-c arranged into three sequentially arranged humidity regions 272a-c of conveyor path 192. Accordingly, as a plant trough 104 progresses along conveyor path 192, the plant trough 104 will move from one humidity region 272a, where it had been exposed to a first relative humidity from humidity supply module 268a, to another humidity region 272b where it is exposed to relative humidity from subsequent humidity supply module 268b, and so forth.

Each humidity supply module 268 may have any design suitable for manipulating the relative humidity of the ambient air to which the cannabis plants in the plant troughs 104 are exposed. For example, each humidity supply module 268 may include one or many outlets 276 (e.g. from a distribution conduit 280 as shown or an outlet nozzle) that delivers water vapor to regions of the environment where at least a portion of conveyor 108 is located. Each humidity supply module 268 may include or be fluidly coupled to an individualized or shared water vapor supply (not shown), such as for example an ultrasonic, evaporative, or steam vaporizer. In some embodiment, every humidity supply module 268 is configured to produce different relative humidities in a respective humidity region 272 of conveyor path 192 so that cannabis plants in a plant trough 104 may be exposed to continuously changing relative humidities as the plant trough 104 travels along conveyor path 192.

In some embodiments, humidity subsystem 120 may include only one humidity supply module 268. For example, the humidity supply module 268 may be located proximate conveyor upstream end 176 (e.g. where humidity supply module 268a is shown in FIGS. 1-3). This may provide a relative humidity that is highest in an upstream portion of conveyor path 192, and that decreases gradually towards the downstream end of conveyor path 192.

Irrespective of the number of humidity supply modules 268, each humidity supply module 268 may have an output regulated manually (i.e. by a user) or automatically by a controller based on a humidity program (e.g. according to a hygrometer and a target relative humidity).

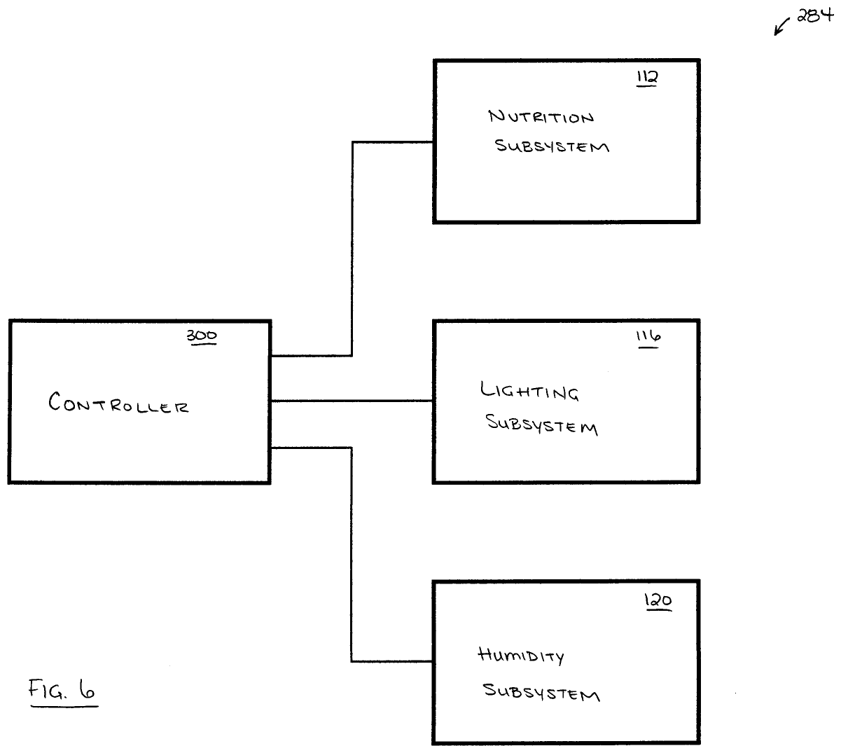

Reference is now made to FIG. 6, which shows a schematic illustration of system control network 284 of system 100, in accordance with an embodiment. As shown, system control network 284 may include a controller 300 that is communicatively coupled to one or more (or all) of plant nutrition subsystem 112, lighting subsystem 116, and humidity subsystem 120 for directing the operation of subsystems 112, 116, 120. In alternative embodiments, one or more (or all) of subsystems 112, 116, 120 has its own separate controller 300.

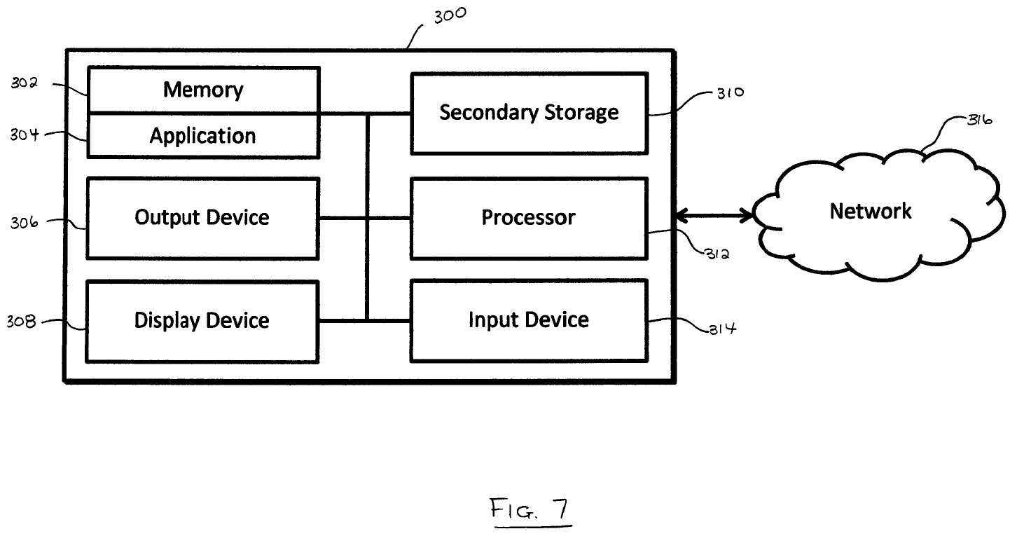

FIG. 7 shows a schematic illustration of controller 300 (which may be a shared controller of multiple subsystems or a dedicated controller for a single subsystem). Generally, a controller 300 can be a server computer, desktop computer, notebook computer, or another special purpose computing device. In at least one embodiment, controller 300 includes a connection with a network 316 such as a wired or wireless connection to the Internet or to a private network. In some cases, network 316 includes other types of computer or telecommunication networks. This may permit controller 300 to be accessed, controlled, and/or monitored remotely (e.g. on a user's smartphone or remote computer).

In the example shown, device 300 includes a memory 302, an application 304, an output device 306, a display device 308, a secondary storage device 310, a processor 312, and an input device 314. In some embodiments, device 300 includes multiple of any one or more of memory 302, application 304, output device 306, display device 308, secondary storage device 310, processor 312, and input device 314. In some embodiments, device 300 does not include one or more of applications 304, second storage devices 310, network connections, input devices 314, output devices 306, and display devices 308.

Memory 302 can include random access memory (RAM) or similar types of memory. Also, in some embodiments, memory 302 stores one or more applications 304 for execution by processor 312. Applications 304 correspond with software modules including computer executable instructions to perform processing for the functions and methods described herein. For example, applications 304 may include one or more (or all) of a nutrition program, lighting program, and humidity program, which govern the operation of nutrition, lighting, and humidity subsystems by controller 300. Secondary storage device 310 can include a hard disk drive, floppy disk drive, CD drive, DVD drive, Blu-ray drive, solid state drive, flash memory or other types of non-volatile data storage.

In some embodiments, device 300 stores information in a remote storage device, such as cloud storage, accessible across a network, such as network 316 or another network. In some embodiments, device 300 stores information distributed across multiple storage devices, such as memory 302 and secondary storage device 310 (i.e. each of the multiple storage devices stores a portion of the information and collectively the multiple storage devices store all of the information). Accordingly, storing data on a storage device as used herein and in the claims, means storing that data in a local storage device, storing that data in a remote storage device, or storing that data distributed across multiple storage devices, each of which can be local or remote.

Generally, processor 312 can execute computer readable instructions (which may also be referred to as programs or applications). The computer readable instructions can be stored in memory 302 or in secondary storage 310, or can be received from remote storage accessible through network 316, for example. When executed, the computer readable instructions can configure the processor 312 (or multiple processors 312, collectively) to perform the acts described herein with reference to nutrition, lighting, and humidity subsystems, for example.

Input device 314 can include any device for entering information into device 300. For example, input device 314 can be a keyboard, key pad, cursor-control device, touch-screen, camera, or microphone. Input device 314 can also include input ports and wireless radios (e.g. Bluetooth®, or 802.11x) for making wired and wireless connections to external devices.

Display device 308 can include any type of device for presenting visual information. For example, display device 308 can be a computer monitor, a flat-screen display, a projector or a display panel.

Output device 306 can include any type of device for presenting a hard copy of information, such as a printer for example. Output device 306 can also include other types of output devices such as speakers, for example. In at least one embodiment, output device 306 includes one or more of output ports and wireless radios (e.g. Bluetooth®, or 802.11x) for making wired and wireless connections to external devices.

FIG. 7 illustrates one example hardware schematic of a device 300. In alternative embodiments, device 300 contains fewer, additional or different components. In addition, although aspects of an implementation of device 300 are described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM.

Reference is now made to FIGS. 6-7. As discussed above, plant nutrition subsystem 112, lighting subsystem 116, and humidity subsystem 120 may be configured or controlled to provide cannabis plants with nutrition formulated to promote greater throughput density of cannabis plants, in part by contributing to the cannabis plants skipping the vegetative stage of growth. One or more (or all) of subsystems 112, 116, and 120 may have static hardware configurations, and/or one or more (or all) of subsystems 112, 116, and 120 may be dynamically operated by a controller 300 according to a program (e.g. nutrition, lighting, and/or humidity program) in order to produce the environmental conditions described below.

Conventionally, cannabis plants have three stages of growth: a clone stage, a vegetative stage, and a flower stage. As summarized in Table 1 below, the clone stage may last 14 days, with lighting conditions that include 20 hours continuous light at an intensity of 100 μmol/(s-m²) and 4 hours continuous darkness per 24 hour period, a relative humidity greater than 75%, and a nutrition ratio of [calcium and nitrate] to [phosphorous and potassium] of 2.3:1. The target plant size at the conclusion of the clone stage has a height of 10 cm and a width of 5 cm.

TABLE 1
Conventional Clone Stage

| | Day- | | | Nutrition | Plant Size |
|---|---|---|---|---|---|
| Stage | Night | Light | Relative | [Ca + | (Height/ |
| Length | Cycle | intensity | Humidity | No₃]:[P + K] | Width) |
| 14 days | 20 hrs | 100 μmol/ | >75% | 2.3:1 | 10 cm/5 cm |
| | light/4 | (s-m²) | | | |
| | hrs dark | | | | |

As summarized in Table 2 below, the vegetative stage may last for 21 days, with lighting conditions that include at least 18 hours continuous light at an intensity of 200 μmol/(s-m²) and at most 6 hours continuous darkness per 24 hour period, a relative humidity less than 75%, and a nutrition ratio of [calcium and nitrate] to [phosphorous and potassium] of 2.3:1 The target plant size at the conclusion of the clone stage has a height of 35 cm and a width of 25 cm.

TABLE 2
Conventional Vegetative Stage

| | Day- | | | Nutrition | Plant Size |
|---|---|---|---|---|---|
| Stage | Night | Light | Relative | [Ca + | (Height/ |
| Length | Cycle | intensity | Humidity | No₃]:[P + K] | Width) |
| 21 days | >18 hrs | 200 μmol/ | <75% | 2.3:1 | 35 cm/25 cm |
| | light/<6 | (s-m²) | | | |
| | hrs dark | | | | |

As summarized in Table 3 below, the flower stage may last for 56 days, with lighting conditions that include 10-14 hours continuous light at an intensity of 200 μmol/(s-m²) and 14-10 hours continuous darkness per 24 hour period, a relative humidity less than 50%, and a nutrition ratio of [calcium and nitrate] to [phosphorous and potassium] of 0.76:1. The target plant size at the conclusion of the clone stage has a height of 75 cm and a width of 50 cm. The final plant density is about 6.5 plants per square meter.

TABLE 3
Conventional Flower Stage

| | Day- | | | Nutrition | Plant Size |
|---|---|---|---|---|---|
| Stage | Night | Light | Relative | [Ca + | (Height/ |
| Length | Cycle | intensity | Humidity | No₃]:[P + K] | Width) |
| 56 days | 10-14 hrs | 200 μmol/ | <50% | 0.77:1 | 75 cm/50 cm |
| | light/10- | (s-m²) | | | 6.5plants/m² |
| | 14 hrs | | | | |
| | dark | | | | |

Referring to FIGS. 2 and 6, conveyor path 192 may include a clone stage 326 followed immediately by a flower stage 330 with no vegetative stage between them. Clone stage 326 may include one or more sequentially arranged clone stage zones 334, and flower stage 330 may include one or more sequentially arranged flower stage zones 338. With a stage 326, 330, each zone 334, 338 may have a different combination of nutrition, humidity, and lighting. For example, within a stage 326, 330, each zone 334, 338 may be formed by different combinations of intersecting nutrition, lighting, and humidity regions 204, 264, 272. As an example, the illustrated embodiment shows clone stage 326 having 3 zones 334, and a flower stage 330 having 4 zones 338. In some embodiments, one or more (or all) of subsystems 112, 116, 120 provides output (i.e. nutrition, lighting, or humidity) that varies continuously along one or both stages 326, 330 so that the number of zones 334, 338 within that or those stages 326, 330 is effectively innumerable (i.e. infinite). The total growing duration for a cannabis plant in system 100 may be a sum of the clone and flower stage durations. In some embodiments, the total growing duration may be at least 50 days, such as for example 66 to 81 days.

In some embodiments, plant nutrition subsystem 112 may supply nutrition to plant troughs 104 that varies according to the position along conveyor path 192, as described above. The nutrition supplied in clone stage 326 may include a nutrition ratio of [calcium and nitrate] to [phosphorous and potassium] of at least 3.3:1 (e.g. 3.3:1 to 4.3:1), such as for example a nutrition ratio of at least 4:1. Such high nutrition ratios may enhance growth of the stalks and leaves during the clone stage. In addition, the duration of the clone stage 326 may be 16-20 days, which is substantially longer than a traditional clone stage. Consequently, system 100 may produce cannabis plants that at the end of the clone stage 326 have an average height of at least 6.5 cm (e.g. 6.5-8 cm) and an average diameter of at least 13 cm (e.g. 13-17 cm). See Table 4 for an example.

TABLE 4
Example of Clone Stage

| | Day- | | | Nutrition | Plant Size |
|---|---|---|---|---|---|
| Stage | Night | Light | Relative | [Ca + | (Height/ |
| Length | Cycle | intensity | Humidity | No₃]:[P + K] | Width) |
| 16-20 | 18-22 hrs | 75-125 | >75% | >3.3:1 | 6.5-8 cm/ |
| days | light/6- | μmol/(s-m²) | | | 13-17 cm |
| | 2 hrs dark | | | | |

Still referring to FIGS. 2 and 6, system 100 may deliberately omit a vegetative stage. Instead, after clone stage 326, conveyor path 192 may proceed to a flower stage 330. In the flower stage, nutrition, lighting, and humidity subsystems 112, 116, 120 may cooperate to produce mature cannabis plants, with fully developed bud growth, but with a height that may not require trellis supports, and a width that allows for a substantially greater number of cannabis plants per unit area. Furthermore, the combined durations of the clone and vegetative stages 326, 330 may be substantially less than traditional methods. Accordingly, system 100 may provide substantially greater throughput density of mature cannabis plants (i.e. number of cannabis plants grown to maturity per unit time, per unit facility area) than conventional methods.

In the flower stage 330, lighting subsystem 116 may provide an average of flower stage days, a majority of flower stage days, or all flower stage days, with a day-night cycle that includes 10-14 hours light (e.g. continuous or intermittent light) and 14-10 hours darkness (e.g. continuous or intermittent darkness) per 24 hour period. In some embodiments, the hours of light may decrease between one flower stage zone (e.g. 338a) and a subsequent flower stage zone (e.g. 338b).

In some embodiments, lighting subsystem 116 may provide an average of flower stage days, a majority of flower stage days, or all flower stage days, with a light intensity (during light hours) of at least 300 μmol/(s-m²). In some embodiments, at least one of the flower stage zones 338 has a light intensity (during light hours) of at least 350 μmol/(s-m²). For example, flower stage 330 may include a light intensity (during light hours) that increases from 200-300 μmol/(s-m²) in one flower stage zone (e.g. 338a) to 350-450 μmol/(s-m²) in a subsequent flower stage zone (e.g. 338b). In some embodiments, the light intensity (during light hours) increases continually through the flower stage 330, with a minimum light intensity of 200-300 μmol/(s-m²) and a maximum light intensity of 400-500 μmol/(s-m²). As the plant matures, the ability of the plants to handle the increased light intensity will improve yields and quality.

Alternatively or in addition to the characteristics of the lighting subsystem 116 described above in respect of the flower stage, nutrition subsystem 112 may provide an average of flower stage days, a majority of flower stage days, or all flower stage days, with a nutrition ratio of [calcium and nitrate] to [phosphorous and potassium] of at least 1:1 (e.g. 1:1 to 1.8:1). This is a substantially higher ratio than conventional methods. This may allow the mature plants to obtain additional nutrition for the development of flowers and to maintain plant balance. In some embodiments, the nutrition ratio may decrease from one flower stage zone (e.g. 338b) to a subsequent flower stage zone (e.g. 338c). In some embodiments, the nutrition ratio may decrease continually through the flower stage, with a maximum nutrition ratio of 2 to 3 and a minimum nutrition ratio of 0.5 to 1.

Alternatively or in addition to the characteristics of the lighting system 116 described above in respect of the flower stage, and alternatively or in addition to the characteristics of the nutrition subsystem 112 described above in respect of the flower stage, humidity subsystem 120 may provide average of flower stage days, a majority of flower stage days, or all flower stage days, with a relative humidity of less than 60%. In some embodiment, the relative humidity may decrease from one flower stage zone (e.g. 338b) to a subsequent flower stage zone (e.g. 338c). In some embodiments, the relative humidity may decrease continually through the flower stage. For example, the relative humidity may decrease from a maximum relative humidity of 60-70% to a minimum relative humidity of 45-55%.

The flower stage 330 may have a duration of 50-60 days. At the end of the flower stage (e.g. at conveyor downstream end 180), the cannabis plants in plant troughs 104 may have reached full maturity ready for harvest with an average height of between 30-40 cm, an average diameter of 25-35 cm, and an average density of at least 35 plants/m² (e.g. 40-60 plants/m²). Inter-trough spacing 168 (measured center-to-center) may be 5 to 10 inches (e.g. 6.5 to 9 inches, such as 8 inches). As compared to conventional methods, the cannabis plants are shorter so that they may not require trellises to support them properly upright, and they are narrower with a much higher plant density. Furthermore, the traditional method has a total growing duration across all stages of about 91 days, whereas system 100 has a growing duration of only about 66-80 days. Together, the increased plant density and decreased growing duration combine to provide substantially higher throughput density of mature cannabis plants (i.e. number of cannabis plants grown to maturity per unit time, per unit facility area) than conventional methods. See Table 5 for an example.

TABLE 4
Example of Flower Stage

| | Day- | | | Nutrition | Plant Size |
|---|---|---|---|---|---|
| Stage | Night | Light | Relative | [Ca + | (Height/ |
| Length | Cycle | intensity | Humidity | No₃]:[P + K] | Width) |
| 50-60 | 10-14 hrs | 180-450 | <60% | >1:1 | 30-40 cm/ |
| days | light/14- | μmol/(s-m²) | | | 25-35 cm |
| | 10 hrs | | | | |
| | dark | | | | |

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

### Items

Item 1: A method of growing a plurality of cannabis plants, the method comprising:
conveying the cannabis plants along a conveyor path in a downstream direction from a conveyor upstream end to a conveyor downstream end over the course of at least 50 days,
the conveyor path including, between the conveyor upstream end and the conveyor downstream end, a clone stage having one or more sequentially arranged clone stage zones, and a flower stage having one or more sequentially arranged flower stage zones, the flower stage positioned immediately downstream of the clone stage,
   exposing the cannabis plants, when in the clone stage, to a light intensity of between 75-125 μmol/(s-m²) during light periods of a clone stage day-night cycle having between 18-22 hours light and 6-2 hours darkness per 24 hour period; and
   exposing the cannabis plants, when in the flower stage, to a light intensity of between 180-450 μmol/(s-m²) during light periods of a flower stage day-night cycle having between 10-14 hours light and 14-10 hours darkness per 24 hour period; and
   removing the cannabis plants from the conveyor for harvesting after the cannabis plants reach the conveyor downstream end, wherein at the conveyor downstream end the cannabis plants have an average height of 30-40 cm, an average diameter of 25-35 cm, and an average density of at least 35 plants/m².
   Item 2: The method of any preceding item, wherein:
   said conveying comprises conveying the cannabis plants through the clone stage in a clone stage duration of 16-20 days.
   Item 3: The method of any preceding item, wherein:
   said conveying comprises conveying the cannabis plants through the flower stage in a flower stage duration of 50-60 days.
   Item 4: The method of any preceding item, wherein:
   said conveying comprises conveying the cannabis plants from the conveyor upstream end to the conveyor downstream end in a growing duration that is a sum of the clone stage duration and the flower stage duration.
   Item 5: The method of any preceding item, wherein:
   the light intensity during light period in at least one of the flower stage zones is greater than 350 μmol/(s-m²).
   Item 6: The method of any preceding item, wherein:
   the flower stage includes a first flower stage zone upstream of a second flower stage zone, and the light intensity during light periods in the first flower stage zone is 200-300 μmol/(s-m²) and the light intensity during light periods in the second flower stage zone is 350-450 μmol/(s-m²).
   Item 7: The method of any preceding item, further comprising:
   providing clone stage nutrition to the cannabis plants when in the clone stage, the clone stage nutrition having a ratio of (calcium and nitrate) to (phosphorous and potassium) of at least 3.3:1.
   Item 8: The method of any preceding item, further comprising:
   providing flower stage nutrition to the cannabis plants when in the flower stage, the flower stage nutrition having a ratio of (calcium and nitrate) to (phosphorous and potassium) of at least 1:1.
   Item 9: The method of any preceding item, wherein:
   clone stage humidity in the clone stage is greater than 75%, and
   flower stage humidity in at least one of the flower stage zones is less than 60%.
   Item 10: The method of any preceding item, wherein:
   flower stage humidity decreases towards the conveyor downstream end.
   Item 11: A method of growing a plurality of cannabis plants, the method comprising:
   conveying the cannabis plants along a conveyor path in a downstream direction from a conveyor upstream end to a conveyor downstream end over the course of at least 50 days,
the conveyor path including, between the conveyor upstream end and the conveyor downstream end, a clone stage having one or more sequentially arranged clone stage zones, and a flower stage having one or more sequentially arranged flower stage zones, the flower stage positioned immediately downstream of the clone stage,
   providing clone stage nutrition to the cannabis plants when in the clone stage, the clone stage nutrition having a ratio of (calcium and nitrate) to (phosphorous and potassium) of at least 3.3:1,
   providing flower stage nutrition to the cannabis plants when in the flower stage, the flower stage nutrition having a ratio of (calcium and nitrate) to (phosphorous and potassium) of at least 1:1, and
   removing the cannabis plants from the conveyor for harvesting after the cannabis plants reach the conveyor downstream end, wherein at the conveyor downstream end the cannabis plants have an average height of 30-40 cm, and an average density of at least 35 plants/m².
   Item 12: The method of any preceding item, wherein:
   said conveying comprises conveying the cannabis plants through the clone stage in a clone stage duration of 16-20 days.
   Item 13: The method of any preceding item, wherein:
   said conveying comprises conveying the cannabis plants through the flower stage in a flower stage duration of 50-60 days.
   Item 14: The method of any preceding item, wherein:
   said conveying comprises conveying the cannabis plants from the conveyor upstream end to the conveyor downstream end in a growing duration that is a sum of the clone stage duration and the flower stage duration.
   Item 15: The method of any preceding item, wherein:
   upon exiting the clone stage, the cannabis plants have an average height of at least 13 cm and an average diameter of at least 6.5 cm.
   Item 16: The method of any preceding item, further comprising:
   exposing the cannabis plants, when in at least one of the flower stage zones, to a light intensity of at least 350 μmol/(s-m²).
   Item 17: The method of any preceding item, wherein:
   clone stage humidity in the clone stage is greater than 75%, and
   flower stage humidity in at least one of the flower stage zones is less than 60%.
   Item 18: The method of any preceding item, wherein:
   flower stage humidity decreases towards the conveyor downstream end.
   Item 19: A system for growing cannabis plants, the system comprising:
   a conveyor having a conveyor upstream end, a conveyor downstream end, and a downstream direction, the conveyor defining a conveyor path,
the conveyor path including, between the conveyor upstream end and the conveyor downstream end, a clone stage and a flower stage, the flower stage positioned immediately downstream of the clone stage; and
   a lighting subsystem having one or more lighting modules that expose the clone stage of the conveyor path to a light intensity of between 75-125 μmol/(s-m²) during light periods of a clone stage day-night cycle having between 18-22 hours light and 6-2 hours darkness per 24 hour period, and that expose the flower stage of the conveyor path to a light intensity of between 180-450 μmol/(s-m²) during light periods of a flower stage day-night cycle having between 10-14 hours light and 14-10 hours darkness per 24 hour period.
   Item 20: The system of any preceding item, wherein:
   the conveyor provides a center-to-center plant trough spacing at the conveyor downstream end of 6.5 to 9 inches.
   Item 21: The system of any preceding item, wherein:
   the conveyor provides a clone stage duration through the clone stage of 16-20 days.
   Item 22: The system of any preceding item, wherein:
   the conveyor provides a flower stage duration through the flower stage of 50-60 days.
   Item 23: The system of any preceding item, wherein:
   the lighting subsystem provides a light intensity, during light periods in at least a portion of the flower stage, of greater than 350 μmol/(s-m²).
   Item 24: The system of any preceding item, wherein:
   the flower stage includes a first flower stage zone upstream of a second flower stage zone, and the lighting subsystem provides a light intensity during light periods in the first flower stage zone of 200-300 μmol/(s-m²) and a light intensity during light periods in the second flower stage zone of 350-450 μmol/(s-m²).
   Item 25: A system for growing cannabis plants, the system comprising:
   a conveyor having a conveyor upstream end, a conveyor downstream end, and a downstream direction, the conveyor defining a conveyor path,
the conveyor path including, between the conveyor upstream end and the conveyor downstream end, a clone stage having one or more sequentially arranged clone stage zones, and a flower stage having one or more sequentially arranged flower stage zones, the flower stage positioned immediately downstream of the clone stage; and
   a plant nutrition subsystem having one or more nutrition modules that supply nutrition in the clone stage of the conveyor path with a ratio of (calcium and nitrate) to (phosphorous and potassium) of at least 3.3:1, and that supply nutrition in the flower stage of the conveyor path with a ratio of (calcium and nitrate) to (phosphorous and potassium) of at least 1:1.
   Item 26: The system of any preceding item, wherein:
   the conveyor provides a center-to-center plant trough spacing at the conveyor downstream end of 6.5 to 9 inches.
   Item 27: The system of any preceding item, wherein:
   the conveyor provides a clone stage duration through the clone stage of 16-20 days.
   Item 28: The system of any preceding item, wherein:
   the conveyor provides a flower stage duration through the flower stage of 50-60 days.

1. A method of growing a plurality of cannabis plants, the method comprising:
conveying the cannabis plants along a conveyor path in a downstream direction from a conveyor upstream end to a conveyor downstream end over the course of at least 50 days,
the conveyor path including, between the conveyor upstream end and the conveyor downstream end, a clone stage having one or more sequentially arranged clone stage zones, and a flower stage having one or more sequentially arranged flower stage zones, the flower stage positioned immediately downstream of the clone stage,
exposing the cannabis plants, when in the clone stage, to a light intensity of between 75-125 μmol/(s-m²) during light periods of a clone stage day-night cycle having between 18-22 hours light and 6-2 hours darkness per 24 hour period; and
exposing the cannabis plants, when in the flower stage, to a light intensity of between 180-450 μmol/(s-m²) during light periods of a flower stage day-night cycle having between 10-14 hours light and 14-10 hours darkness per 24 hour period; and
removing the cannabis plants from the conveyor for harvesting after the cannabis plants reach the conveyor downstream end, wherein at the conveyor downstream end the cannabis plants have an average height of 30-40 cm, an average diameter of 25-35 cm, and an average density of at least 35 plants/m².

2. The method of claim 1, wherein:
said conveying comprises conveying the cannabis plants through the clone stage in a clone stage duration of 16-20 days.

3. The method of claim 2, wherein:
said conveying comprises conveying the cannabis plants through the flower stage in a flower stage duration of 50-60 days.

4. The method of claim 3, wherein:
said conveying comprises conveying the cannabis plants from the conveyor upstream end to the conveyor downstream end in a growing duration that is a sum of the clone stage duration and the flower stage duration.

5. The method of claim 1, wherein:
the light intensity during light period in at least one of the flower stage zones is greater than 350 μmol/(s-m²).

6. The method of claim 1, wherein:
the flower stage includes a first flower stage zone upstream of a second flower stage zone, and the light intensity during light periods in the first flower stage zone is 200-300 μmol/(s-m²) and the light intensity during light periods in the second flower stage zone is 350-450 μmol/(s-m²).

7. The method of claim 1, further comprising:
providing clone stage nutrition to the cannabis plants when in the clone stage, the clone stage nutrition having a ratio of (calcium and nitrate) to (phosphorous and potassium) of at least 3.3:1.

8. The method of claim 1, further comprising:
providing flower stage nutrition to the cannabis plants when in the flower stage, the flower stage nutrition having a ratio of (calcium and nitrate) to (phosphorous and potassium) of at least 1:1.

9. The method of claim 1, wherein:
clone stage humidity in the clone stage is greater than 75%, and
flower stage humidity in at least one of the flower stage zones is less than 60%.

10. The method of claim 9, wherein:
flower stage humidity decreases towards the conveyor downstream end.

11. A method of growing a plurality of cannabis plants, the method comprising:
conveying the cannabis plants along a conveyor path in a downstream direction from a conveyor upstream end to a conveyor downstream end over the course of at least 50 days,
the conveyor path including, between the conveyor upstream end and the conveyor downstream end, a clone stage having one or more sequentially arranged clone stage zones, and a flower stage having one or more sequentially arranged flower stage zones, the flower stage positioned immediately downstream of the clone stage,
providing clone stage nutrition to the cannabis plants when in the clone stage, the clone stage nutrition having a ratio of (calcium and nitrate) to (phosphorous and potassium) of at least 3.3:1,
providing flower stage nutrition to the cannabis plants when in the flower stage, the flower stage nutrition having a ratio of (calcium and nitrate) to (phosphorous and potassium) of at least 1:1, and
removing the cannabis plants from the conveyor for harvesting after the cannabis plants reach the conveyor downstream end, wherein at the conveyor downstream end the cannabis plants have an average height of 30-40 cm, and an average density of at least 35 plants/m².

12. The method of claim 11, wherein:
said conveying comprises conveying the cannabis plants through the clone stage in a clone stage duration of 16-20 days.

13. The method of claim 12, wherein:
said conveying comprises conveying the cannabis plants through the flower stage in a flower stage duration of 50-60 days.

14. The method of claim 13, wherein:
said conveying comprises conveying the cannabis plants from the conveyor upstream end to the conveyor downstream end in a growing duration that is a sum of the clone stage duration and the flower stage duration.

15. (canceled)

16. (canceled)

17. The method of claim 11, wherein:
clone stage humidity in the clone stage is greater than 75%, and
flower stage humidity in at least one of the flower stage zones is less than 60%.

18. The method of claim 17, wherein:
flower stage humidity decreases towards the conveyor downstream end.

19. A system for growing cannabis plants, the system comprising:
a conveyor having a conveyor upstream end, a conveyor downstream end, and a downstream direction, the conveyor defining a conveyor path,
the conveyor path including, between the conveyor upstream end and the conveyor downstream end, a clone stage and a flower stage, the flower stage positioned immediately downstream of the clone stage; and
a lighting subsystem having one or more lighting modules that expose the clone stage of the conveyor path to a light intensity of between 75-125 μmol/(s-m²) during light periods of a clone stage day-night cycle having between 18-22 hours light and 6-2 hours darkness per 24 hour period, and that expose the flower stage of the conveyor path to a light intensity of between 180-450 μmol/(s-m²) during light periods of a flower stage day-night cycle having between 10-14 hours light and 14-10 hours darkness per 24 hour period.

20. The system of claim 19, wherein:
the conveyor provides a center-to-center plant trough spacing at the conveyor downstream end of 6.5 to 9 inches.

21. (canceled)

22. (canceled)

23. The system of claim 19, wherein:
the lighting subsystem provides a light intensity, during light periods in at least a portion of the flower stage, of greater than 350 μmol/(s-m²).

24. The system of claim 19, wherein:
the flower stage includes a first flower stage zone upstream of a second flower stage zone, and the lighting subsystem provides a light intensity during light periods in the first flower stage zone of 200-300 μmol/(s-m²) and a light intensity during light periods in the second flower stage zone of 350-450 μmol/(s-m²).

25.-28. (canceled)
